(19) United States
(12) Patent Application Publication
(10) Pub. No.: US 2006/0151523 A1
(43) Pub. Date: Jul. 13, 2006

(54) Metered liquid dispenser

(76) Inventor: Michael Fetzer, Birmingham, MI (US)

Correspondence Address: HARNESS, DICKEY & PIERCE, P.L.C., P.O. BOX 828, BLOOMFIELD HILLS, MI, 48303, US

(21) Appl. No.: 11/244,353

(22) Filed: Oct. 5, 2005

Related U.S. Application Data
(60) Provisional application No. 60/643,408, filed on Jan. 12, 2005.

(51) Int. Cl. B67D 5/30

(52) U.S. Cl. 222/14; 222/16; 222/23

(57) ABSTRACT

A metered liquid dispenser. The meter liquid dispenser includes an inlet communicating with a supply of liquid, an outlet, a user interface for selecting a predetermined amount of liquid to be dispensed, and a control unit for controlling the amount dispensed through the outlet. The control unit includes a flow meter measuring an amount of fluid dispensed through the outlet, and a control valve.

### CROSS-REFERENCE TO RELATED APPLICATIONS

This application claims the benefit of U.S. Provisional Application No. 60/643,408, filed on Jan. 12, 2005. The disclosure of the above application is incorporated herein by reference.

### INTRODUCTION

Water conserving devices for public flush toilets and faucets are known. Such devices typically use motion sensors or infrared sensors to dispense a pre-measured amount of water without input from the user as to the amount dispensed.

While the known devices are satisfactory for their purposes, there is still a need for liquid dispensers that can measure and dispense an amount of liquid based on user input.

### SUMMARY

The present teachings provide a metered liquid dispenser that dispenses a predetermined amount of liquid based on user input. The meter liquid dispenser includes an inlet communicating with a supply of liquid, an outlet, a user interface for selecting a predetermined amount of liquid to be dispensed, and a control unit for controlling the amount dispensed through the outlet. The control unit includes a flow meter measuring an amount of fluid dispensed through the outlet, and a control valve.

The present teachings provide a method for dispensing a predetermined amount of liquid from a liquid storage container. The method includes providing a user interface for entering input data, entering a unit of measurement corresponding an amount of liquid to be dispensed, measuring the amount of liquid being dispensed, and stopping liquid flow when an amount equal to the unit of measurement is dispensed.

Further areas of applicability of the present invention will become apparent from the description provided hereinafter. It should be understood that the description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of a metered liquid dispenser according to the present teachings;

FIG. 2 is a front view of the metered liquid dispenser of FIG. 1;

FIG. 3 is a side view of the metered liquid dispenser of FIG. 1;

FIG. 4 a front view of a metered liquid dispenser according to the present teachings, shown in a new installation for a sink with a control unit under the sink;

FIG. 5A is a front view of a metered liquid dispenser according to the present teachings, shown installed on an existing faucet;

FIG. 5B is side view of metered liquid dispenser of FIG. 5A;

FIG. 6A is a plan view of a metered liquid dispenser according to the present teachings, the metered liquid dispenser shown installed as a secondary faucet in a sink with a primary faucet; and

FIG. 6B is a side view of the metered liquid dispenser of FIG. 6A, showing a control unit for the metered liquid dispenser installed under the sink.

### DESCRIPTION OF VARIOUS EMBODIMENTS

The following description is merely exemplary in nature and is in no way intended to limit the invention, its application, or uses. For example, although the present teachings are illustrated for applications of water control and measurement in home faucets, such as faucets for kitchen sinks, bathtubs, shower stalls and the like, the present teachings can be used for any liquid dispensing devices, in commercial, industrial, clinical and laboratory settings, including boats, recreational or commercial vehicles, such as buses, trucks, trains, and airplanes. Accordingly, the present teachings can be used for dispensing predetermined amounts of juices and other drinks, and distilled, purified, and pharmaceutical or other liquids, from an appropriate storage container.

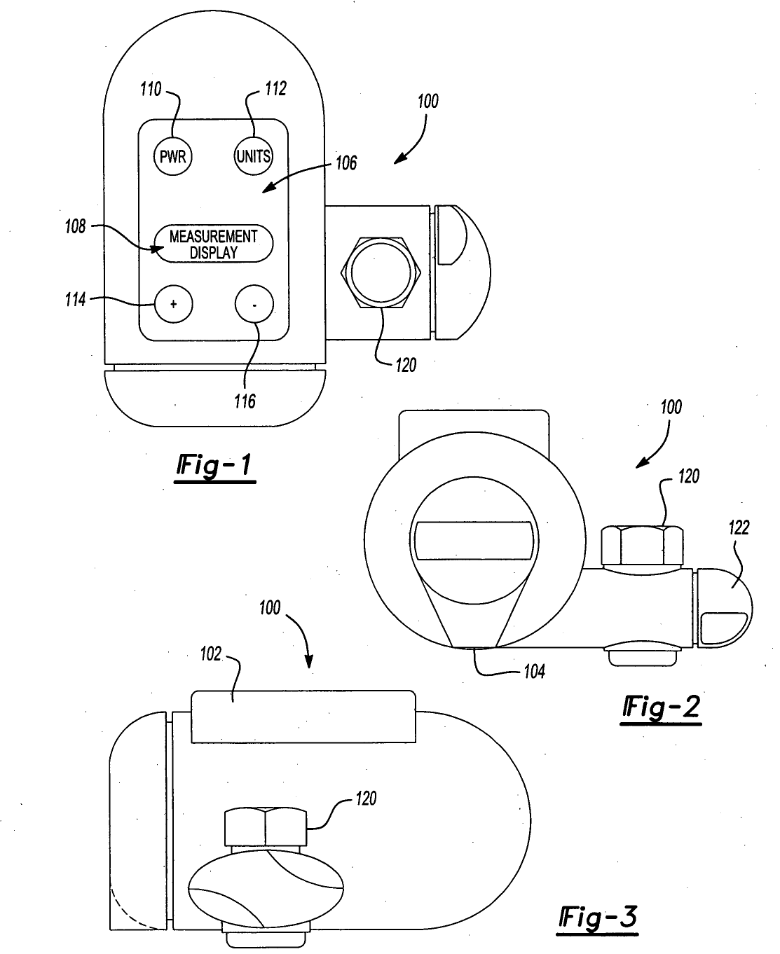

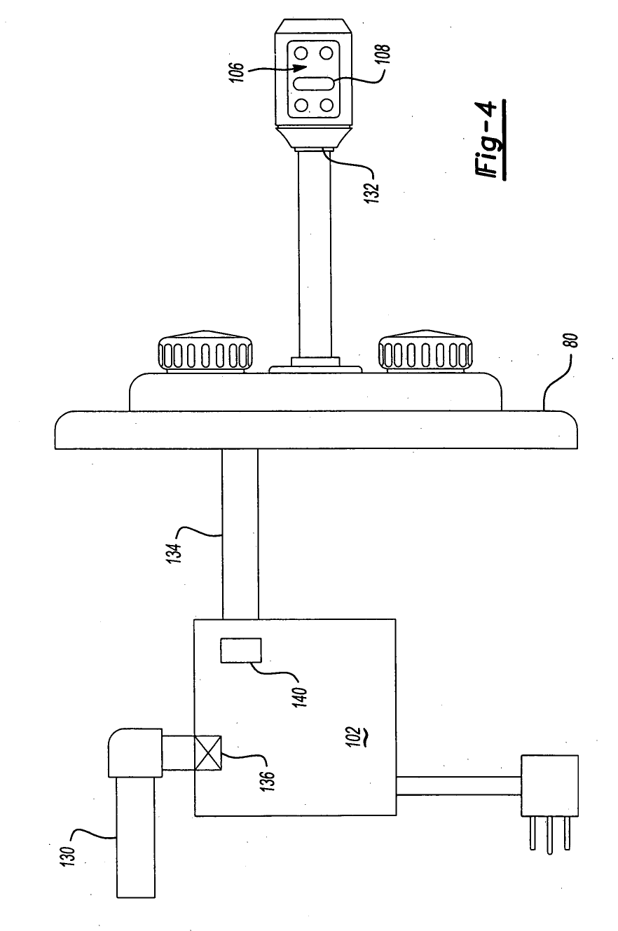

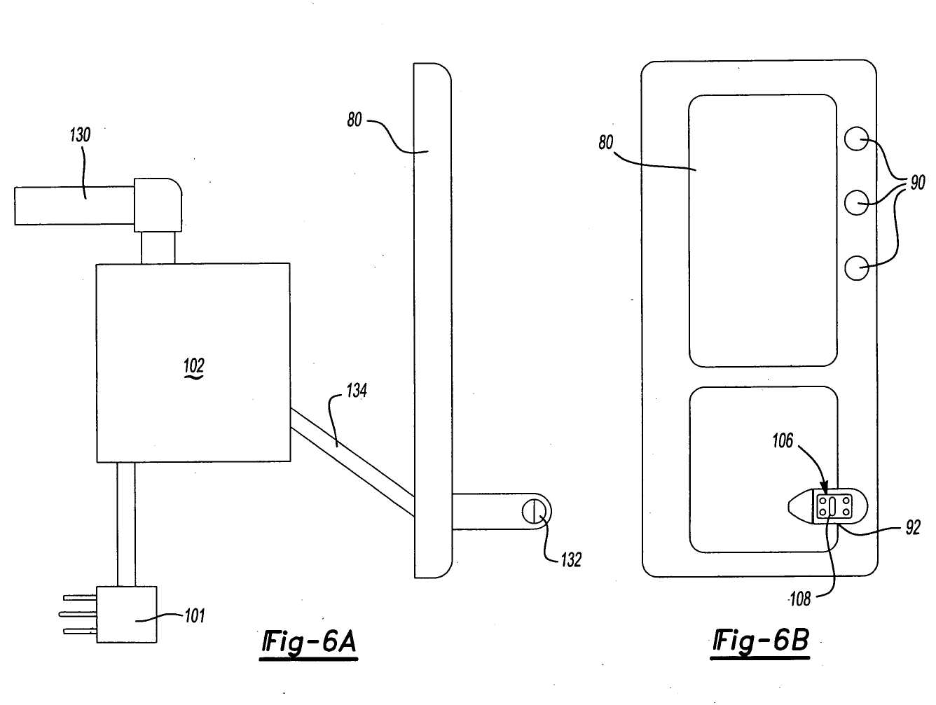

Referring to FIGS. 1-3, various views of an exemplary metered liquid dispenser 100 are illustrated. The metered liquid dispenser 100 can include a control unit 102 for measuring a selectable amount of liquid and controlling the flow of the measured amount. The control unit 102 can be connected to a power source, with an AC adapter 101, for example, and can be separate from the metered liquid dispenser 100 and located in a remote position, such as under a sink 80, as shown in FIGS. 4 and 6A. The metered liquid dispenser 100 can include an outlet 104 for dispensing the metered liquid, an electronic measurement display 108 showing various units of measurement, including fractions or multiples of cups, ounces, pints, liters, etc.

A user interface 106 communicating with the control unit 102 remotely or wirelessly can be used to select a pre-determined amount of liquid in selected units, as desired by the user. The user interface 106 can be, for example, a touch pad, a keyboard or other input entry device, and can include appropriate electronics, such as a microprocessor, programmable logic controller or other processing and storage modules. In the exemplary illustration of FIG. 1, the user interface 106 can include a power on/off button 110, a unit selection button 106, and plus and minus buttons 114, 116 for selecting amounts incrementally in increasing or decreasing order. It should be appreciated that the description of the user interface 106 is merely illustrative, and various other known configurations and features are possible, including, for example, pictorial menus, and/or alphanumeric lists of units and quantities, as well as other features, including programmable timers, etc.

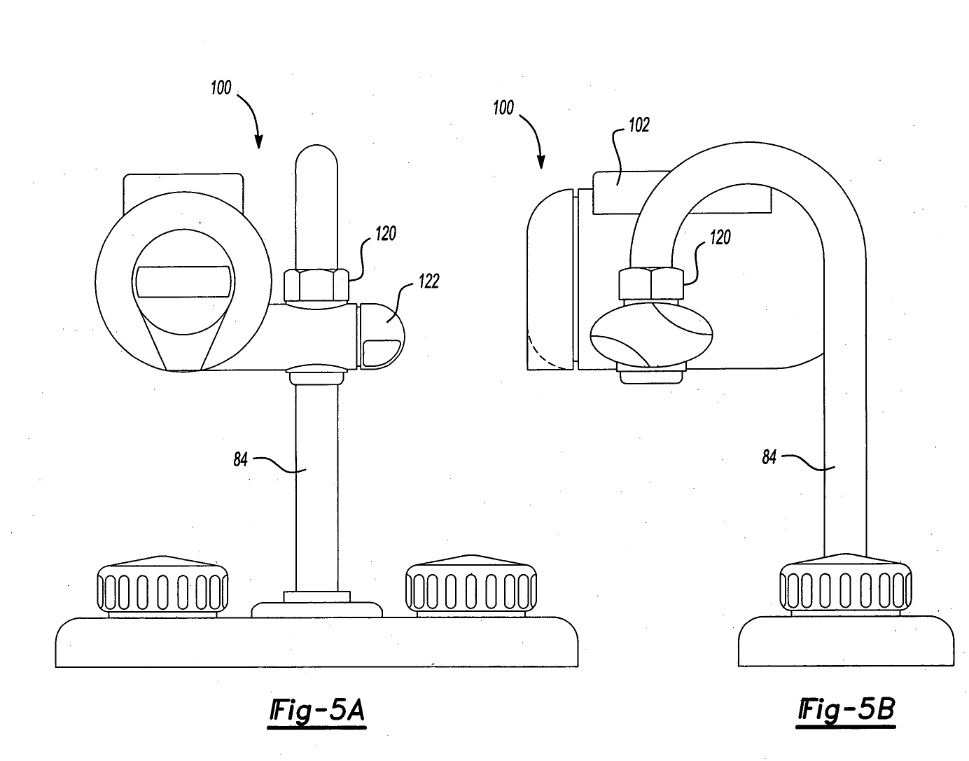

The metered liquid dispenser 100 can include a faucet adapter 120 for installing the metered liquid dispenser 100 on a pre-existing faucet 84 or other non-metered liquid dispenser, as illustrated in FIGS. 5A and 5B. The metered liquid dispenser 100 can also include a fluid diverter 122, which can be used to selectively direct water flow through the metered liquid dispenser 100 or to bypass the metered liquid dispenser 100.

Referring to FIG. 4, liquid can be directed to the metered liquid dispenser 100 from an inlet 130, which is connected to a water supply or other liquid storage container. The measured amount of liquid is directed to an aerator 132 from a metered outlet 134. An electromagnetic low voltage valve or other known valve 136 can be used to shut off the liquid flow when the desired amount of liquid is dispensed. The amount of liquid dispensed can be measured using a flow meter 140. The flow meter 140 can be a turbine flow meter that determines the amount of liquid passing through the turbine by counting revolutions of the vanes of the turbine, which rotate by the action of the flow. For a turbine flow meter 140, liquid measurement is independent of the liquid pressure, which can fluctuate, especially for public water lines. It will be appreciated, however, that other flow meters 140 can be used, depending on the application. The flow meter 140 and the flow control valve 136 can be integrated with the control unit 140.

Referring to FIGS. 5A and 5B, the metered liquid dispenser 100 can be installed as a retrofit on an existing faucet 84 using the adapter 120, which can receive the neck of the faucet 84. Referring to FIG. 4, the metered liquid dispenser 100 can also be installed in a new faucet installation with the control unit 102 positioned remotely under the sink 80. Referring to FIGS. 6A and 6B, the metered liquid dispenser 100 can be installed as a secondary or additional faucet associated with a hole 92 of the sink, adjacent to an existing primary faucet that utilizes holes 90 of the sink 80.

It will be appreciated that the metered liquid dispenser 100 can be used to conserve water, especially in scarce situations, such as in boats, vehicles, planes or in geographic and other areas with limited supply and or high demand. It can also be used for any kitchen or laboratory usage to simplify cooking steps or laboratory procedures by providing predetermined amounts of liquid automatically and on demand based on user input.

The foregoing discussion discloses and describes merely exemplary arrangements of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A metered liquid dispenser comprising:
an inlet communicating with a liquid storage container;
an outlet;
a user interface for selecting a predetermined amount of liquid to be dispensed; and
a control unit for controlling the amount dispensed through the outlet, the control unit comprising a flow meter measuring an amount of fluid dispensed through the outlet, and a control valve.

2. The metered liquid dispenser of claim 1, wherein the flow meter is a turbine flow meter.

3. The metered liquid dispenser of claim 2, wherein the control valve is an electromagnetic low voltage valve.

4. The metered liquid dispenser of claim 3, wherein the user interface comprises an electronic input entry device.

5. The metered liquid dispenser of claim 1, further comprising an adapter for installing the metered liquid dispenser to an existing non-metered liquid dispenser.

6. The metered liquid dispenser of claim 5, further comprising a diverter for selectively bypassing the metered liquid dispenser.

7. The metered liquid dispenser of claim 1, wherein the control unit can positioned remotely from the user interface.

8. The metered liquid dispenser of claim 7, wherein the user interface can be positioned adjacent to or on a faucet and the control unit can be positioned under a sink associated with the faucet.

9. The metered liquid dispenser of claim 1, wherein the user interface and the control unit can be positioned as an integral unit adjacent to or on a faucet.

10. The metered liquid dispenser of claim 1, wherein the user interface comprises an electronic measurement display for displaying units of measurement.

11. The metered liquid dispenser of claim 10, further comprising unit selection buttons.

12. A method for dispensing a predetermined amount of liquid from a supply of liquid, the method comprising:
providing a user interface for entering input data;
entering a unit of measurement corresponding an amount of liquid to be dispensed;
measuring the amount of liquid being dispensed; and
stopping liquid flow when an amount equal to the unit of measurement is dispensed.

13. The method of claim 12, wherein measuring the amount of liquid comprises:
directing liquid flow through a turbine flow meter; and
counting revolutions of the turbine flow meter.

14. The method of claim 12, wherein stopping liquid flow comprises controlling a flow control valve.

15. The method of claim 14, further comprising by-passing the flow control valve.
